(19) United States
(12) Patent Application Publication
(10) Pub. No.: US 2025/0306405 A1
(43) Pub. Date: Oct. 2, 2025

(54) SILICON PHOTONIC INTEGRATED CIRCUITS WITH ENHANCED THERMAL ISOLATION OF HEATER ELEMENTS

(71) Applicant: Intel Corporation, Santa Clara, CA (US)

(72) Inventors: Kelly Magruder, Albuquerque, NM (US); Harel Frish, Albuquerque, NM (US); Aditi Mallik, Cupertino, CA (US); John Heck, Berkeley, CA (US); Giovanni Gilardi, Campbell, CA (US); Saeed Fathololoumi, Los Gatos, CA (US)

(73) Assignee: Intel Corporation, Santa Clara, CA (US)

(21) Appl. No.: 18/621,790

(22) Filed: Mar. 29, 2024

(51) Int. Cl. G02F 1/01

(52) U.S. Cl. CPC G02F 1/0147; G02F 1/011

(57) ABSTRACT

Silicon photonic (SiPh) integrated circuit (PIC) comprising an optical waveguide heater element is thermally isolated by one or more voids within a dielectric material that is over the heater element. A void over a heater element may be formed by patterning a sacrificial material feature that is then embedded within the dielectric material. The sacrificial material is removed through an opening in the dielectric material and the opening is then occluded to define a void that may be retained as a permanent feature having a low thermal conductivity. The void over the heater element may, along with one of more voids adjacent to the heater element and/or below an optical waveguide, may enhance thermal isolation of a heater element, enhancing its power efficiency.

### BACKGROUND

Photonic integrated circuits (PICs) are increasingly important in high-performance computing, data center, and cloud computing applications. The use of silicon in photonics (SiPh), enables high-volume, low-cost and highly integrated PICs.

SiPh PICs may include optical waveguides fabricated on substrates comprising silicon. Heater elements fabricated near lengths of the waveguides may be employed to modulate signal phasing in the optical domain. Heater power efficiency (mW/x) is an important metric of PIC, which may determine whether a SiPh is suitable for a particular application, such as an Optical Compute Interconnect (OCI) application and/or a co-packaged optics (CPO) application. Accordingly, SiPh PIC architectures and techniques that improve heater element efficiency would be commercially advantageous.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a flow diagram of methods for fabricating an optical-electrical integrated circuit (OEI) device with enhanced power efficiency, in accordance with some embodiments;

FIG. 2A is a flow diagram of methods for fabricating a PIC including a heater element having enhanced thermal isolation, in accordance with some embodiments;

FIG. 2B is a flow diagram of methods for fabricating a PIC including a heater element having enhanced thermal isolation, in accordance with some further embodiments;

FIG. 3A and FIG. 3B are plan and cross-sectional profile views of a region of a PIC substrate including a heater element over an optical waveguide, in accordance with some embodiments;

FIG. 4A and FIG. 4B are plan and cross-sectional profile views illustrating the formation of a sacrificial feature over a heater element within a region of a PIC, in accordance with some embodiments;

FIG. 5A and FIG. 5B are plan and cross-sectional profile views illustrating formation of dielectric material over a sacrificial feature within a region of a PIC, in accordance with some embodiments;

FIG. 6A and FIG. 6B are plan and cross-sectional profile views illustrating formation of openings in dielectric material over and adjacent to a heater element within a region of a PIC, in accordance with some embodiments;

FIG. 7A and FIG. 7B are plan and cross-sectional profile views illustrating removal of sacrificial material from within a region of a PIC, in accordance with some embodiments;

FIG. 8A and FIG. 8B are plan and cross-sectional profile views illustrating the occlusion of voids over, adjacent to, and a under heater element within a region of a PIC, in accordance with some embodiments;

FIG. 9 is a plan view illustrating a void isolated heater element within a region of a PIC, in accordance with some alternative embodiments;

FIG. 10 is a cross-sectional view of an OEIC device including a PIC that has a heater element with enhanced power efficiency, in accordance with some embodiments;

FIG. 11 illustrates a computing platform comprising the OEIC illustrated in FIG. 10, in accordance with some embodiments; and

FIG. 12 is a functional block diagram of an electronic computing device, that may implement one or more of the components of the computing platform illustrated in FIG. 11, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

A silicon photonic (SiPh) device comprising a heater element between a length of an optical waveguide and one or more overlying voids (i.e., “overvoids”) is described below. The void may be located in close proximity to the heater element, significantly enhancing thermal isolation of the heater element. Through the practice of embodiments herein, a heater element may require less power to modulate waveguide optical properties, thereby increasing heater element power efficiency.

In further embodiments, one or more voids adjacent to a resistive heater element may further enhance thermal isolation of the heater element. When voids adjacent to a heater element (i.e., “side-voids”) are combined with one or more overvoids, heater element efficiency may be more dramatically enhanced. When overvoids and adjacent voids are further combined with one or more underlying voids (i.e., “undervoids”), heater element efficiency may be all the more enhanced.

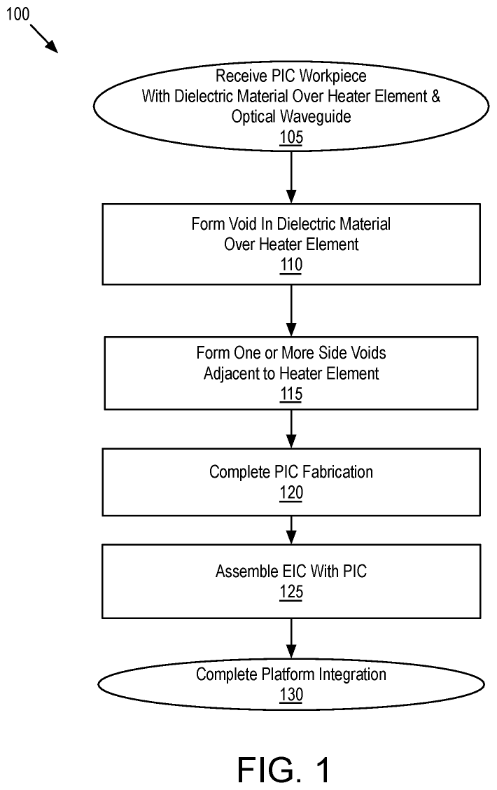

FIG. 1 is a flow diagram of methods 100 for fabricating an OEIC with improved heater power efficiency, in accordance with some embodiments. Methods 100 may be practiced to fabricate a silicon-based PIC device having one or more of the structural attributes described herein. Methods 100 may also be practiced to fabricate other PIC devices to similarly improve heater efficiency and/or otherwise improve thermal isolation of one or more devices integrated within the PIC. Although examples are further described in the context of SiPh implementations, the exemplary PIC substrate architectures may also be implemented in alternative substrate technologies (e.g., exclusively III-V) without departing from the principles disclosed herein.

Methods 100 begin at input 105 where a PIC workpiece is received. In exemplary embodiments, the PIC workpiece comprises one or more PIC structures including a semiconductor substrate material and a buried insulator layer, for example between a top (front) side substrate layer and another substrate layer on a bottom (back) side of the insulator layer. The buried insulator layer may be fabricated upstream of methods 100, for example with any wafer bonding process, or other buried insulator process known to be suitable for forming semiconductor-on-insulator (SOI) substrate material stacks.

A PIC structure of the workpiece received at input 105 further comprises one or more optical waveguides, for example having been fabricated from a top side crystalline silicon layer upstream of methods 100. The optical waveguides may have any suitable architecture, such as a substantially planar ridge waveguide, a rib waveguide, or the like. The PIC structure further includes one or more dielectric materials cladding the optical waveguides. Although the composition of the dielectric material(s) may vary with implementation, in some examples the dielectric material(s) are silicon-based (e.g., predominantly silicon and oxygen).

A PIC structure of the workpiece received at input 105 further comprises a heater element, which has been fabricated proximal to a length of the optical waveguides. In exemplary embodiments, the heater element is a resistive heater element comprising a material (e.g., metal, doped polycrystalline or monocrystalline silicon, etc.) that is to undergo Joule heating when powered to pass an electrical current along a length of the heater element. The heater element generally includes a feature of material having a suitable resistivity. In exemplary embodiments, the heater element is located over a length of an optical waveguide that is to be heated by the heater element. However, heater elements may instead be laterally adjacent to a length of an optical waveguide or even located under (below) a length of an optical waveguide.

Methods 100 continue at block 110 where an overvoid is formed within dielectric material that is over the heater element. The overvoid is to remain as a permanent feature of a PIC die and improves thermal isolation of the heater element by replacing the dielectric material having some solid-state thermal conductivity (K) value with a non-solid of lower thermal conductivity. As described further below, by locating the overvoid immediately above a heater element a heat island of smaller dimensions is possible, which more significantly enhances heater efficiency.

At block 115, one or more side-voids are formed adjacent to the heater element. Like the overvoid, the side-voids are permanent features of a PIC die that can further improve thermal isolation of the heater element by reducing a lateral spread of heat emanating from the heater element. Either block 110 or block 115 may be practiced without the other. However, by practicing a combination of blocks 110 and 115 heater efficiency of a PIC may be enhanced more significantly. For such combinations, either block 110 or block 115 may be performed before the other, or as described further below, at least some aspects of both blocks 110 and 115 may be practiced concurrently.

Methods 100 continue at block 120 where PIC fabrication is completed. At block 120, one or more electrical or optical devices may be fabricated within levels of the PIC that extend over the voids fabricated at block 110 and/or block 115. Any passive or active optical devices may be fabricated within a PIC or assembled upon a PIC according to any technique(s) known in the art. Optical devices may include (de) multiplexers, grating couplers, or output couplers, thermo-optical modulators, semiconductor optical amplifiers (SOAs), photodetectors or lasers, for example. Passive or active electrical devices may also be fabricated within a PIC. In some examples, metal-insulator-metal (MIM) capacitors may be fabricated within backend metallization levels that extend over one or more of the voids fabricated at block 110 and 115.

At block 125, one or more components are assembled with a PIC including a heater element of enhanced efficiency. In some embodiments, an electrical IC (EIC) is assembled on a PIC at block 125. In some other embodiments, an optical output coupler is assembled on a PIC at block 125. In still other embodiments both an EIC and an optical output coupler with assembly with a PIC.

Methods 100 end at block 130 where an OEIC assembly is further integrated (e.g. assembled) with a host component, for example integrating the OEIC with any number of additional PICs, EICs, and OEIC assemblies. Depending on the implementation, the host component may be a printed circuit board (PCB), a package substrate, or any interposer suitable for the further integration of an OEIC assembly that has an optical I/O interface.

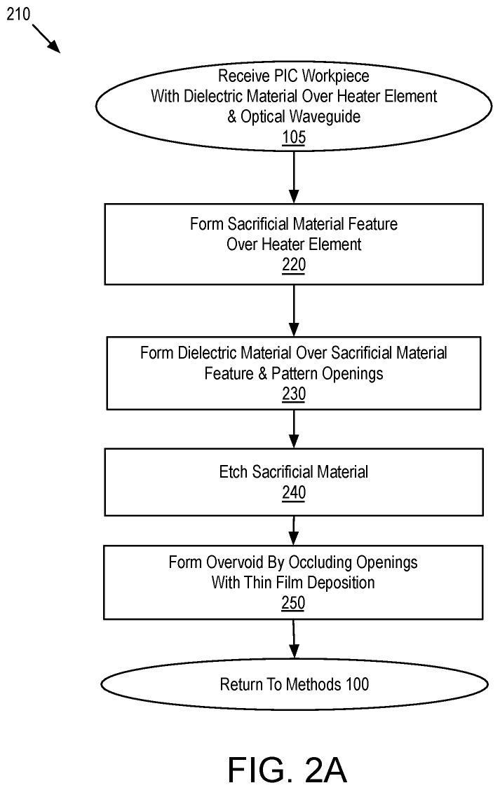

FIG. 2A is a flow diagram of methods 210 for fabricating a PIC in accordance with some embodiments where a void is formed over the heater element. Methods 210 may be practiced at block 110 (FIG. 1), for example. FIG. 2B is a flow diagram of methods 215 for fabricating a PIC in accordance with some further embodiments where a void is formed adjacent to the heater element. Methods 215 may be practiced at block 115 (FIG. 1), for example. Methods 210 (FIG. 2A) may be practiced independently of methods 215. However, in exemplary embodiments both methods 210 and 215 (FIG. 2B) are practiced to enhance thermal isolation of a heater element within a PIC.

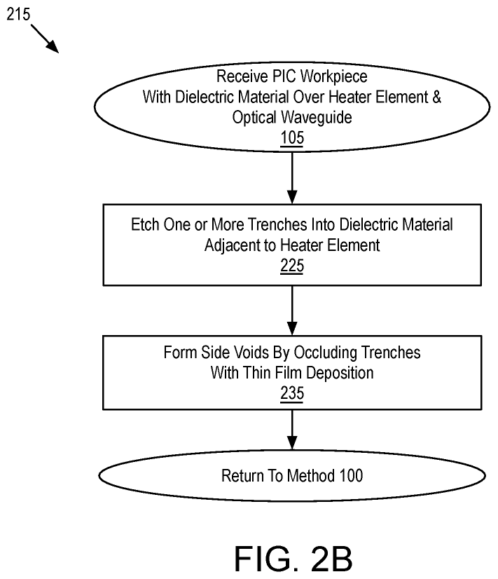

Methods 210 (FIG. 2A) begin with receipt of the PIC structure including a dielectric material and a heater element over a length of an optical waveguide, for example substantially as described above. FIG. 3A is a plan view of a monolithic PIC structure 300, in accordance with some exemplary embodiments. FIG. 3B is profile view of PIC substrate 300 along the b-b′ line shown in FIG. 3A. PIC structure 300 comprises a portion of a substrate material layer 301. In exemplary embodiments, substrate material layer 301 comprises substantially monocrystalline silicon. Substrate material layer 301 is a base layer of an SOI substrate material stack further comprising a buried insulator material layer 302. In exemplary embodiments, where substrate material layer 301 is substantially pure silicon, insulator material layer 302 is advantageously predominantly silicon and oxygen and may be essentially pure silicon dioxide (e.g., SiO₂).

One or more additional substrate material layers may be over insulator material layer 302. In the example illustrated in FIG. 3B, buried insulator material layer 302 is between substrate material layer 301 and a device material layer from which an optical waveguide 320 has been patterned. In some embodiments where substrate material layer 301 is substantially monocrystalline silicon, the device material layer (i.e., waveguide 320) is also substantially monocrystalline silicon.

As further illustrated in FIGS. 3A and 3B, PIC structure 300 further includes a dielectric material 310 over insulator material layer 302 and over optical waveguide 320. Dielectric material 310 may have any composition. In some exemplary embodiments, dielectric material 310 is silicon-based, and may be predominantly silicon and oxygen (i.e., SiOₓ) with one example being silicon dioxide (SiO₂). As shown in FIG. 3A, heater element 325 spans a longitudinal length L₁ of waveguide 320 and has a substantially constant transverse width W₁. Length L₁ may vary, for example from hundreds of nanometers (nm) to hundreds of microns (μm). In the illustrated example, heater element 325 comprises two via lands at opposite ends of length L₁ where electrical power is to be applied. Width W₁ may also vary with implementation. In the illustrated example, width W₁ is larger than a transverse width of waveguide 320 and a transverse centerline of heater element 325 substantially centered with a centerline of waveguide 320. Like waveguide 320, heat element 325 is illustrated in dashed line in FIG. 3A to emphasize both are embedded below a top surface of dielectric material 310.

As shown in FIG. 3B, heater element 325 is located over optical waveguide 320. Heater element 325 is spaced apart from underlying portions of waveguide 320 by an intervening thickness T1 of dielectric material 310. Although thickness T1 may vary with implementation, in some examples T1 is at least 500 nm and may be 1 μm, or more. Heater element 325 may comprise any material having a suitable electrical resistivity to convert electrical power into thermal energy during operation of PIC structure 300. In some embodiments, heater element 325 comprises a metal or metal alloy, such as W or Ti. Heater element 325 may also comprise other materials, such as semiconductor materials having a suitable resistivity.

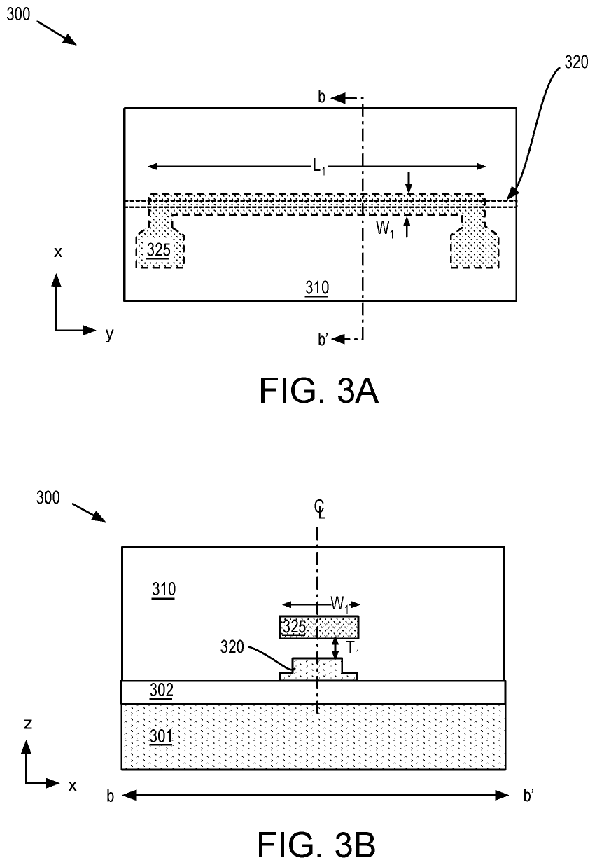

Returning to FIG. 2A, methods 210 continue at block 220 where one or more sacrificial material features are formed over the heater element. The sacrificial material features are dimensioned as structural placeholders for where a void is ultimately to be located within a PIC. Accordingly, transverse width and longitudinal length of the sacrificial material, as well as its thickness, may be determined according to thermal models so as to most impede thermal conduction from the heater element. Mechanical modeling may further dictate a minimum spacing between adjacent sacrificial material features to ensure subsequent void formation does not induce a mechanical failure within a PIC. In the example further illustrated in FIG. 4A and FIG. 4B, a sacrificial material feature 450 has been patterned from a thin film material deposited over dielectric material 310. Sacrificial material feature 450 extends a transverse width W₂ and a continuous longitudinal length L₂ over heater element 325. Length L₂ may vary with implementation. In advantageous embodiments, length L₂ is over one-half of length L₁ (i.e., feature 450 spans at least a majority of length L₁). In the illustrated example length L₂ is greater than the corresponding length L₁ of heater element 325. In other embodiments a plurality of features 450 may span at least a majority of length L₁. Width W₂ may similarly vary with implementation. In advantageous embodiments, width W₂ is over one-half of width W₁ (i.e., feature 450 spans at least a majority of width W₁). Width W₂ is preferably larger than corresponding transverse width W₁ of heater element 325, and may be at least 50% larger that W₁, for example.

As shown in FIG. 4B, sacrificial material feature 450 is substantially centered with a centerline of a transverse width of heater element 325, which may be further substantially centered with a centerline of a transverse width of optical waveguide 320 so that all three structures share a same centerline. Sacrificial material feature 450 is vertically spaced apart from a top surface of heater element 325 by a thickness T₂ of dielectric material 310. In exemplary embodiments, thickness T₂ is less than 1000 nm and advantageously no more 500 nm as a minimal thickness of dielectric material 310 over heater element 325 will ultimately improve heater efficiency. In some embodiments, thickness T₂ is less than 400 nm and may advantageously be in the range of 100-300 nm. Sacrificial material feature 450 may be directly on heater element 325 such that heater element 325 is subsequently exposed during void formation. However, retention of some non-zero thickness of dielectric material between heater element 325 and sacrificial material feature 450 may prevent complications associated with exposing heater element 325 to a void formation process. Sacrificial material feature 450 has a thickness T₃, which may also vary with implementation. In some examples, thickness T₃ is at least 500 nm. In further examples, thickness T₃ is no more than 2 μm.

The composition of sacrificial material feature 450 is different than the composition of dielectric material 310. In advantageous embodiments, sacrificial material feature 450 has a composition that will enable its subsequent removal by a process selective over dielectric material that is surrounding the heater element. Although the composition of sacrificial material feature 450 may vary, in some examples where dielectric material 310 has a silicon-based composition, sacrificial material feature 450 also has a silicon-based composition. In some advantageous embodiments, sacrificial material feature 450 has at least one of a greater concentration of silicon or a greater concentration of nitrogen than dielectric material 310. In some examples where dielectric material 310 is predominantly silicon and oxygen, sacrificial material feature 450 is predominately silicon and nitrogen (SiNₓ), and in some embodiments is Si₃N₄. In other examples where dielectric material 310 is predominantly silicon and oxygen, sacrificial material feature 450 is primarily silicon (e.g., polycrystalline silicon). Sacrificial material feature 450 may also have other compositions, such as a metal-based composition (e.g., W, Ti, etc.), which can also be suitable for embodiments where dielectric material 310 is a silicon-based.

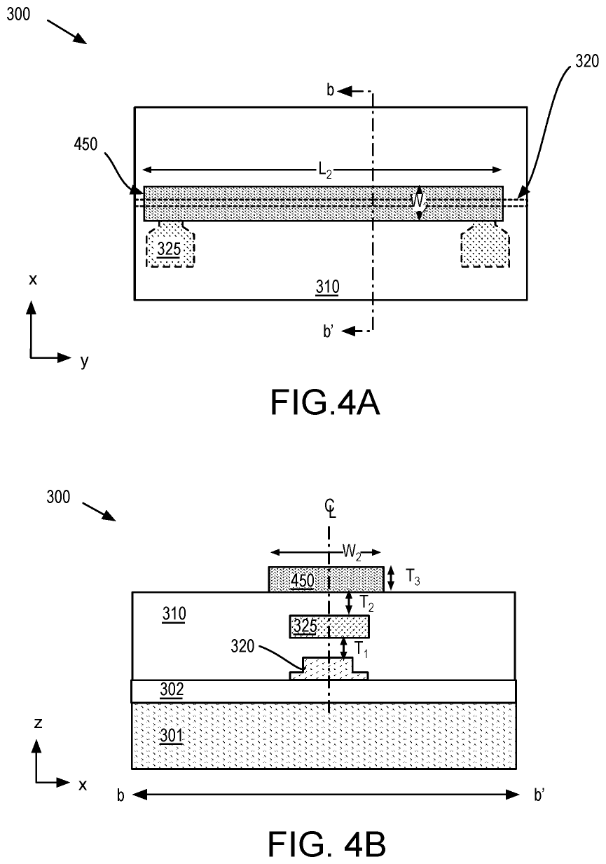

Returning to FIG. 2A, methods 210 continue at block 230 where additional dielectric material of a different composition than that of sacrificial material feature is deposited over the sacrificial material feature. In some embodiments, the same dielectric material that surrounds the underlying optical waveguide is deposited over the sacrificial material feature. Openings are then patterned into the dielectric material to expose one or more portions of the sacrificial material feature. Generally, the openings formed at block 230 are no larger than is needed to pass an etchant of the sacrificial material feature. FIG. 5A and FIG. 5B are plan and cross-sectional profile views illustrating the formation of additional dielectric material 310 over a sacrificial feature 450 within a region of PIC structure 300, in accordance with some embodiments. Any deposition and planarization processes may be practiced to prepare PIC structure 300 for subsequent processing.

Returning to FIG. 2A, methods 210 continue at block 240 where the sacrificial material is removed selectively to the surrounding dielectric material with an etchant that accesses the sacrificial material through the openings formed in the dielectric material deposited at block 230. Removal of the sacrificial material forms one or more cavities within the dielectric material that are precisely located over the heater element. Openings to the cavities are then occluded by depositing another thin film material at block 250. Upon occluding the openings, the cavities become voids sealed within dielectric material of the PIC. Methods 210 may then end, for example by returning to methods 100 (FIG. 1) or otherwise completing PIC fabrication.

As noted above for methods 100, one or more voids may also be formed within dielectric material adjacent to a heater element. FIG. 2B is a flow diagram of methods 215 for fabricating such side-voids to further enhance thermal isolation of a heater element, in accordance with some embodiments. Methods 215 similarly begin at input 105 with receipt of a workpiece including one or more PIC structures. In some embodiments, the workpiece received is substantially as described above. For example, the workpiece may have a PIC structure substantially as described as an input to methods 100 (FIG. 1). In other embodiments, the workpiece further comprises an overvoid, for example substantially as formed by methods 210 (FIG. 2A). In still other embodiments, the workpiece received as an input to methods 215 comprises a PIC structure including a sacrificial material feature as a precursor to an overvoid.

Methods 215 (FIG. 2B) continue at block 225 where one or more trenches are etched into dielectric material that is adjacent to a heater element of a PIC structure. Any suitable lithography process may define a mask pattern locating mask openings adjacent to the heater element. An anisotropic etch process suitable for the dielectric material may form a trench through a thickness of the dielectric material, ideally extending to a depth beyond a depth of the heater element as a means of interrupting thermal conduction pathways through the dielectric material.

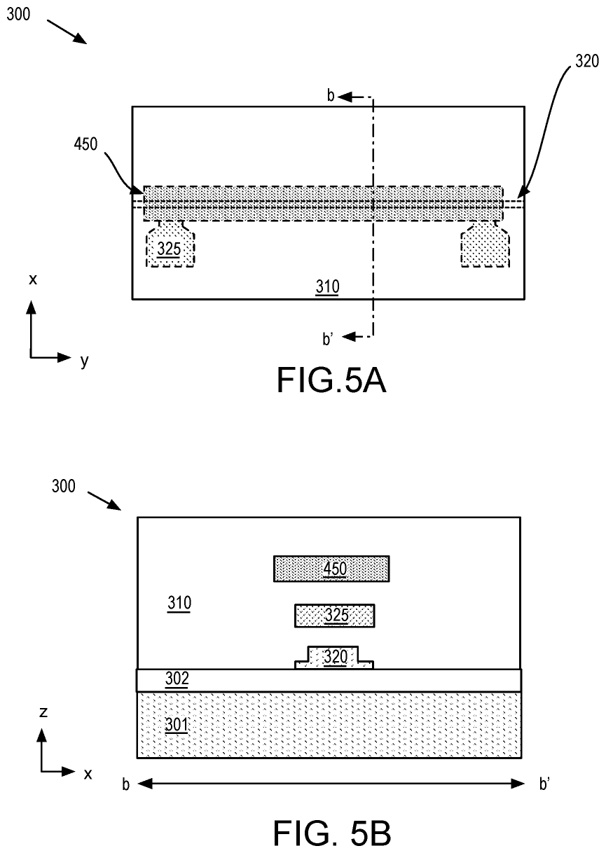

FIG. 6A and FIG. 6B are plan and cross-sectional profile views illustrating formation of two trenches 635 through dielectric material 310 within a region of PIC structure 300 adjacent to opposite sidewalls of heater element 325. In this example, a pair of side trenches 635 extend through an entirety of dielectric material 310, as well as completely through substrate insulator layer 302, thereby exposing substrate material 301 at a bottom of trenches 635. In this example, individual ones of trenches 635 are laterally adjacent opposite sidewalls of heater element 325 and laterally adjacent to opposite sidewalls of sacrificial material feature 450. Although trenches 635 may be spaced any distance D1 from an edge or sidewall of heater element 325, distance D1 may be minimized to improve thermal isolation of heater element 325. However, for some embodiments that further include sacrificial material feature 450, distance D1 may be sufficient to prevent trenches 635 from exposing any portion of sacrificial material feature 450. In some other embodiments, trenches 635 intersect sacrificial material feature 450 such that an overvoid formed when sacrificial material feature 450 is subsequently removed intersects a side-void associated with trenches 635.

As further illustrated in FIG. 6A, trenches 635 extend a longitudinal length L₃. Although length L3 may vary with implementation, in exemplary embodiments length L₃ is over one-half of length L₁. In the illustrated example, length L₃ exceeds the longitudinal length of both heater element 325 and sacrificial material feature 450. Notably, on each side of heater element 325, there are a plurality of elongate trenches 635 spaced end-to-end along length La with each trench end separated from the next by an intervening portion of dielectric material 310. Dielectric material between adjacent trenches 635 may be retained to ensure adequate mechanical support upon a subsequent removal of sacrificial material feature 450. For alternative embodiments lacking an overvoid, a single continuous trench may instead span the entirety of length L₃.

As further illustrated in FIGS. 6A and 6B, openings 651 extend through a thickness of dielectric material 310 to expose a portion of sacrificial material feature 450. Openings 651 may be formed independently of (e.g., before or after) trenches 635. Alternatively, openings 651 and trenches 635 may be formed concurrently (e.g., with a same lithography mask patterning process and/or a same dielectric etch process). In the example illustrated in FIG. 6A, there are a plurality of openings 651 spaced end-to-end along length L₃. Openings 651 may have any polygonal shape, for example to ensure adequate access to sacrificial material feature 450.

For embodiments including a sacrificial material feature over a heater element, the sacrificial material feature may be removed before or after formation of trenches 635. Any isotropic wet and/or dry etch process selective to the sacrificial material may be employed to remove at least some, and advantageously substantially all, of a sacrificial material feature. In one example where the sacrificial material is predominantly silicon and nitrogen (e.g., Si₃N₄), the sacrificial material may be removed with a wet chemical etchant comprising phosphoric acid.

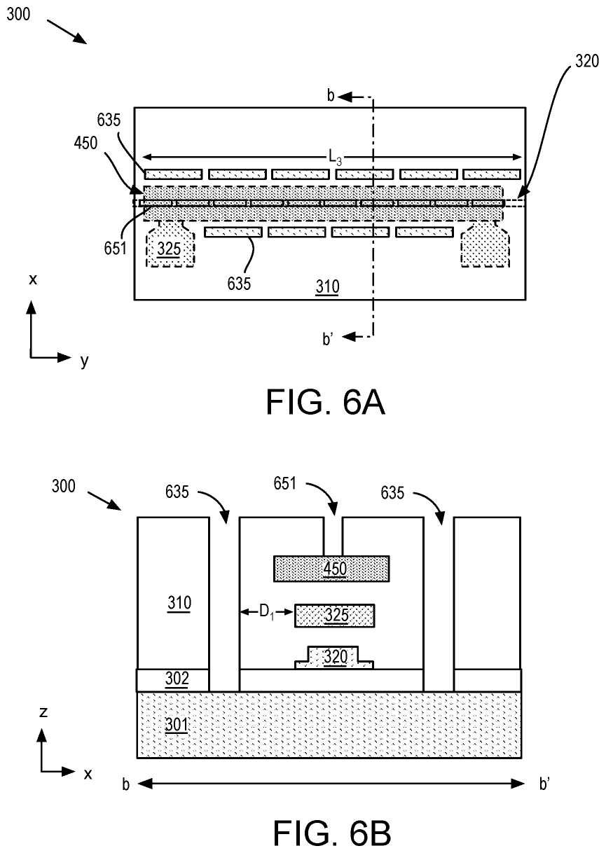

In some embodiments where the sacrificial material feature is removed after formation of trenches 635, one or more etch processes may remove at least a portion of sacrificial material feature 450 exposed by openings 651, and also remove at least a portion of substrate material layer 301 exposed by trenches 635. As further illustrated in FIG. 7A and FIG. 7B, one or more isotropic etch processes has completely removed sacrificial material feature 450, forming a single cavity 750 of width W₂ and length L₂ that spans an entirety of an area of the PIC structure occupied by heater element 325. As further illustrated in FIG. 7B, an isotropic etch process has undercut at least a portion of optical waveguide 320 forming a cavity 760 below at least a portion of heater element 325. For some embodiments where both the sacrificial material feature and substrate material layer 301 are silicon (e.g., polycrystalline and single crystalline silicon), a single isotropic etch process may concurrently form cavities 750 and 760.

Depending on the etch process(es) employed to form cavity 750, some of the surrounding dielectric material may be concurrently etched, for example reducing dielectric thickness T₂ between heater element 325 and cavity 750 to a post-etch thickness T₂′. According, thickness T2′ may be less than 500 nm, and in some embodiments is 100-200 nm.

Returning to FIG. 2B, methods 215 continue at block 235 where side-voids are formed by occluding the trenches with a thin film deposition process, such as a chemical vapor deposition (CVD) having suitable conformality to pinch-off openings in the underlying material. Methods 215 may then end by returning to methods 100 where PIC fabrication is completed and the PIC is further assembled with an EIC. Notably, block 235 is optional for embodiments where subsequent PIC fabrication is insensitive to topography associated with leaving the trenches open. In some exemplary embodiments, a dielectric material (e.g., a silicon-based dielectric material) is deposited at block 235. The deposition performed at block 235 may be substantially the same as that employed to form the overvoid at block 250 of methods 210 (FIG. 2A), in which case the dielectric material occluding the side-voids will be the same as the dielectric material occluding openings to the overvoid.

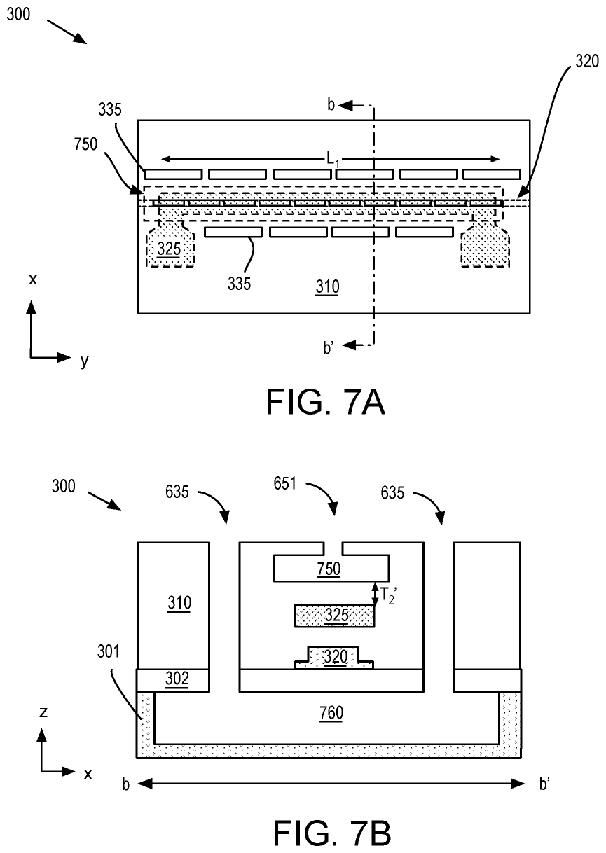

In the example further illustrated in FIG. 8A and FIG. 8B, a dielectric material 810 has been deposited over dielectric material 310, sealing overvoid 851 as well as side-voids 852. Scaling of side-voids 852 also seals undervoid 853 (if present). In some embodiments, dielectric material 810 has substantially the same composition as dielectric material 310 (e.g., predominantly silicon and oxygen). In other embodiments, dielectric material 810 has greater nitrogen content (e.g., SiOₓN_{y}) than dielectric material 310 (e.g., SiOₓ). As shown in FIG. 8B, overvoid 851 has dimensions dependent upon those of the precursor sacrificial material feature. In some embodiments where dielectric material 810 is deposited with a highly non-conformal deposition process (as illustrated in solid line 810A), overvoid 851 may advantageously have substantially the same dimensions as the sacrificial material feature. Side-voids 852 may similarly have substantially the same dimensions as the side trenches. For embodiments where dielectric material 810 is deposited with a highly conformal deposition process (as illustrated in dashed line 810B), overvoid 851 may have dimensions reduced from those the sacrificial material feature. Side-voids 852 may similarly have lateral dimensions smaller than those of the side trenches.

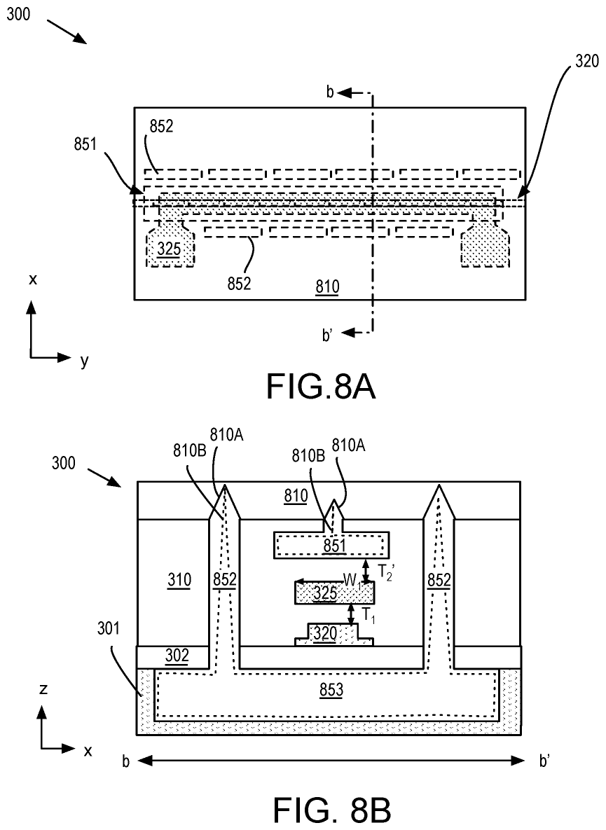

Although FIG. 3A-8A illustrate overvoids, side-voids and undervoids for an exemplary straight length of heater element, the architectures and techniques described are equally applicable to more complex heater element architectures. FIG. 9 is a plan view illustrating a void isolated heater within a region of a PIC structure 900, in accordance with some alternative embodiments. In the illustrated example, heater element 325 has an annular architecture. Overvoid 851 is an annulus overlaying heater element 325 substantially as described above for a linear heater element. Side-voids 852 are coaxially positioned along inside and outside perimeters of heater element 325. Although not illustrated, an undervoid may be similarly annular to substantially surround heater element 325 within a toroidal void that thermally isolates a heater element 325.

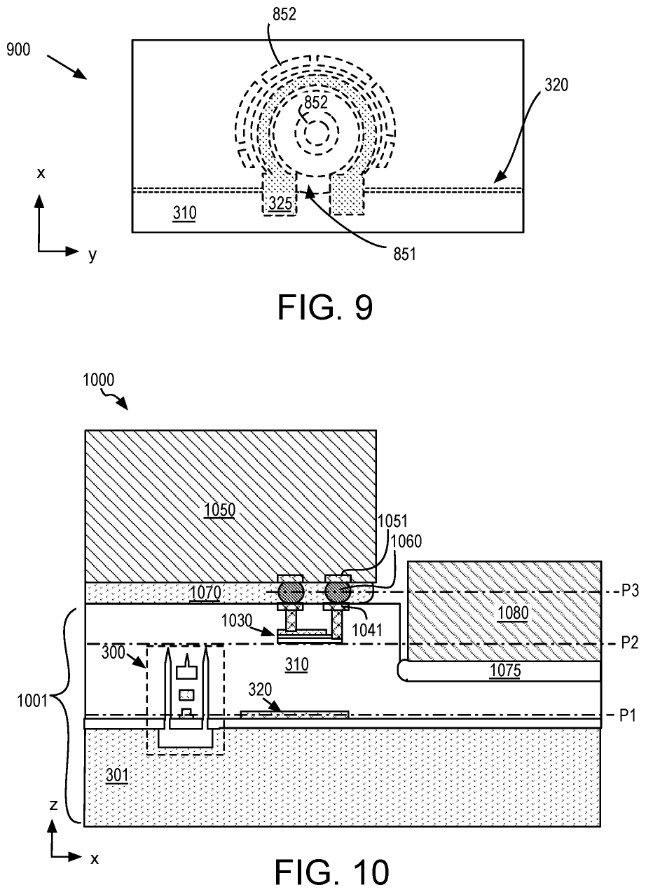

PIC structures and PIC die incorporating the PIC structures described above may be implemented in a wide variety of applications and platforms. FIG. 10 is a cross-sectional view of an OEIC device 1000 including a PIC 1001 that comprises PIC structure 300, in accordance with some illustrative embodiments. OEIC device 1000, may be fabricated according to methods 100 (FIG. 1), for example.

As shown in FIG. 10, optical waveguide 320 is along a first plane P1. Waveguide 320 is optically coupled by any suitable means to an output coupler 1080 assembled over PIC 1001. Output coupler 1080 may have any known architecture, but in some examples comprises a glass preform adhered, for example by an intervening material 1075. Output coupler 1080 may optically interconnect PIC 1001 to an optical source or sink external of PIC 1001. For example, optical coupler 1080 may interface PIC 1001 to a multi-mode or single mode optical fiber core (not depicted). Optical coupler 1080 may comprise one or more mirror facets and/or lenses to couple a mode between an x-y plane PIC 1001 and a vertically or horizontally (e.g., edge) coupled fiber comprising a core surrounded by one or more cladding layers.

As further illustrated in FIG. 10, PIC structure 300 is embedded within PIC 1001, which further comprises one or more electrical interconnect metallization levels above PIC structure 300. In the illustrated example, PIC 1001 includes a MIM capacitor 1030 above a plane P2 that is substantially parallel with plane P1 and passes between PIC structure 300 and MIM capacitor 1030. PIC interconnect metallization features (e.g., conductive vias) electrically couple MIM capacitor 1030 to top-level PIC metallization features 1041. PIC metallization features 1041 electrically couple PIC 1001 to an EIC 1050 through interconnect features 1060 arrayed over another plane P3. Interconnect features 1060 may be solder features, for example, which couple PIC metallization features 1041 to EIC metallization features 1051. An underfill material 1070 is between EIC 1050 and PIC 1001. EIC 1050 may be application-specific IC (ASIC) or a general purpose IC (e.g., programmable processor, electronic memory, etc.).

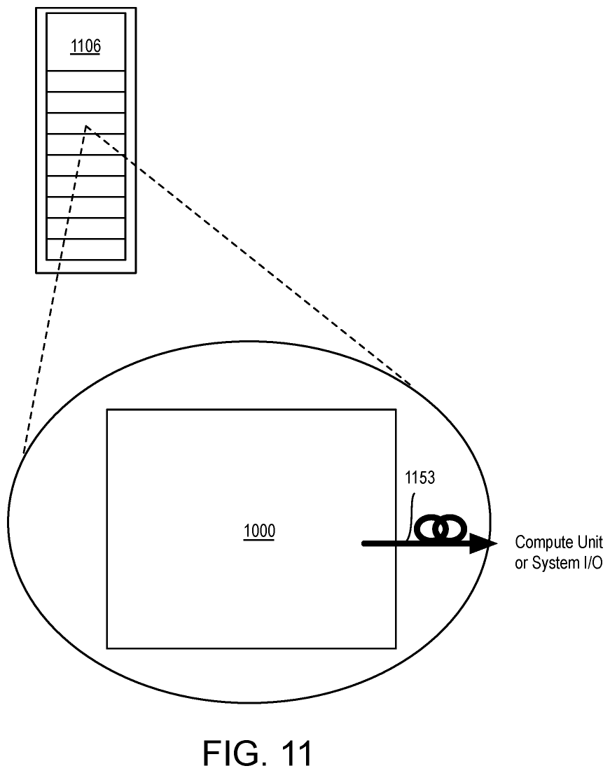

OEICs with enhanced heater element power efficiencies may be implemented in a wide variety of applications and platforms. FIG. 11 illustrates a data server platform 1106 employing an optical link with one or more OEIC 1000, for example thermally isolated heater elements, as described elsewhere herein. Platform 1106 may be any commercial server, for example including any number of high-performance computing platforms or compute units networked together for electronic data processing. As shown in the expanded view, OEIC 1000 is optically coupled off-chip to an optical fiber 1153, for example through top-side coupling or edge output coupler.

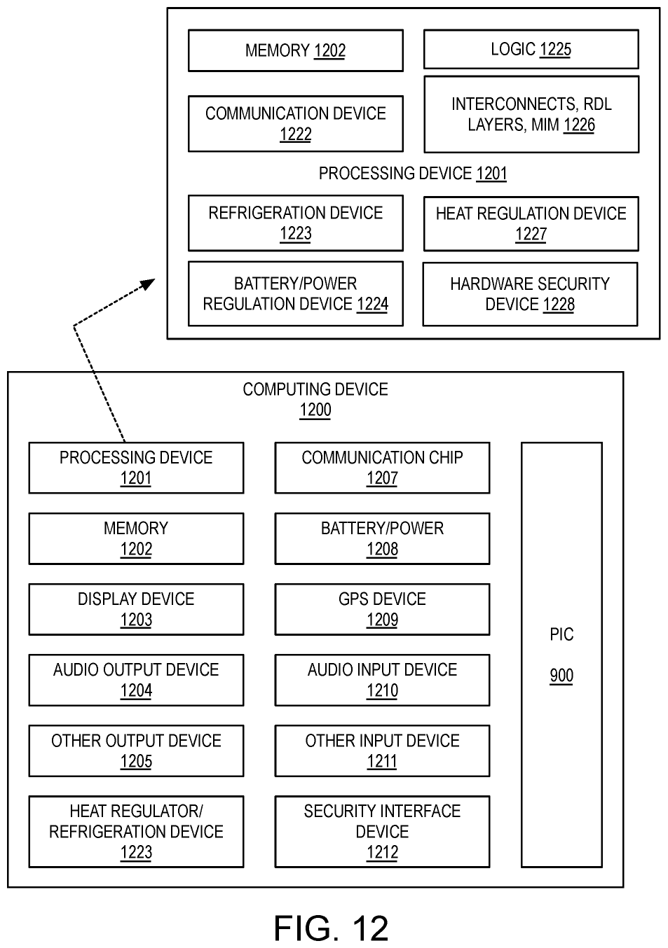

FIG. 12 is a block diagram of a computing device 1200 in accordance with some embodiments. For example, one or more components of computing device 1200 may include any of the PIC structures discussed elsewhere herein. A number of components are illustrated in FIG. 12, but any one or more of these components may be omitted or duplicated, as suitable for the application. In some embodiments, some of the components included in computing device 1200 may be attached to one or more printed circuit boards (e.g., a motherboard). In some embodiments, various ones of these components may be fabricated onto a single system-on-a-chip (SoC) die or implemented with a disintegrated plurality of chiplets or tiles packaged together. Additionally, in various embodiments, computing device 1200 may not include one or more of the components illustrated in FIG. 12, but computing device 1200 may include interface circuitry for coupling to the one or more components. For example, computing device 1200 may not include a display device 1203, but may include display device interface circuitry (e.g., a connector and driver circuitry) to which display device 1203 may be coupled.

Computing device 1200 may include a processing device 1201 (e.g., one or more processing devices). As used herein, the term processing device or processor indicates a device that processes electronic data from registers and/or memory to transform that electronic data into other electronic data that may be stored in registers and/or memory. Processing device 1201 may include a memory 1202, a communication device 1222, a refrigeration/active cooling device 1223, a battery/power regulation device 1224, logic 1225, interconnects 1226, a heat regulation device 1227, and a hardware security device 1228.

Processing device 1201 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable compute units.

Processing device 1201 may include a memory 1202, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, processing device 1201 shares a package with memory 1202. This memory may be used as cache memory and may include embedded dynamic random-access memory (eDRAM) or spin transfer torque magnetic random-access memory (STT-M RAM).

Computing device 1200 may include a heat regulation/refrigeration device 1223. Heat regulation/refrigeration device 1223 may maintain processing device 1201 (and/or other components of computing device 1200) at a predetermined low temperature during operation. This predetermined low temperature may be any temperature discussed elsewhere herein.

In some embodiments, computing device 1200 may include a communication chip 1207 (e.g., one or more communication chips). For example, the communication chip 1207 may be configured for managing wireless communications for the transfer of data to and from computing device 1200. The term “wireless” and its derivatives may be used to describe circuits, devices, systems, methods, techniques, communications channels, etc., that may communicate data through the use of modulated electromagnetic radiation through a nonsolid medium.

Computing device 1200 includes PIC 900, for example having one of the photonic integrated WDM source circuit architectures described herein. PIC 900 may facilitate communication between one or more instances of processing device 1201 and/or one or more instances of memory 1202.

Computing device 1200 may include battery/power circuitry 1208. Battery/power circuitry 1208 may include one or more energy storage devices (e.g., batteries or capacitors) and/or circuitry for coupling components of computing device 1200 to an energy source separate from computing device 1200 (e.g., AC line power).

Computing device 1200 may include a display device 1203 (or corresponding interface circuitry, as discussed above). Display device 1203 may include any visual indicators, such as a heads-up display, a computer monitor, a projector, a touchscreen display, a liquid crystal display (LCD), a light-emitting diode display, or a flat panel display, for example.

Computing device 1200 may include an audio output device 1204 (or corresponding interface circuitry, as discussed above). Audio output device 1204 may include any device that generates an audible indicator, such as speakers, headsets, or earbuds, for example.

Computing device 1200 may include an audio input device 1210 (or corresponding interface circuitry, as discussed above). Audio input device 1210 may include any device that generates a signal representative of a sound, such as microphones, microphone arrays, or digital instruments (e.g., instruments having a musical instrument digital interface (MIDI) output).

Computing device 1200 may include a global positioning system (GPS) device 1209 (or corresponding interface circuitry, as discussed above). GPS device 1209 may be in communication with a satellite-based system and may receive a location of computing device 1200, as known in the art.

Computing device 1200 may include another output device 1205 (or corresponding interface circuitry, as discussed above). Examples include an audio codec, a video codec, a printer, a wired or wireless transmitter for providing information to other devices, or an additional storage device.

Computing device 1200 may include another input device 1211 (or corresponding interface circuitry, as discussed above). Examples may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1200 may include a security interface device 1212. Security interface device 1212 may include any device that provides security measures for computing device 1200 such as intrusion detection, biometric validation, security encode or decode, managing access lists, malware detection, or spyware detection.

Computing device 1200, or a subset of its components, may have any appropriate form factor, such as a server or other networked computing component, a mobile device, a printer, a scanner, a monitor, a set-top box, an entertainment control unit, a vehicle control unit, a digital camera, a digital video recorder, or a wearable computing device.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that practice of the disclosed techniques and architectures is not limited to the embodiments so described but can be modified and altered without departing from the scope of the appended claims. For example, the above embodiments may include specific combinations of features as further provided below.

In first examples, an apparatus comprises an optical waveguide, a heater element over the optical waveguide, and a dielectric material over and adjacent to heater element. One or more voids are within the dielectric material are over the heater element.

In second examples, for any of the first examples the heater element has a transverse width and a longitudinal length and the voids span at least a majority of the longitudinal length.

In third examples, for any of the second examples a width of an individual one of the voids spans at least a majority of the transverse width.

In fourth examples, for any of the second or third examples the voids comprise one void spanning the majority of the longitudinal length and having a transverse width exceeding that of the heater element.

In fifth examples, for any of the first through fourth examples the one or more voids are vertically spaced apart from the heater element by less than 1000 nm.

In sixth examples, for any of the fifth examples the one or more voids are vertically spaced apart from the heater element by no more than a 300 nm thickness of the dielectric material.

In seventh examples, for any of the first through sixth examples the one or more voids are first voids and wherein the apparatus further comprises one or more second voids within the dielectric material and adjacent to a sidewall of the heater element.

In eighth examples, for any of the seventh examples one or more second voids adjacent to the sidewall of the heater element comprise a pair of second voids, and wherein individual ones of the pair of second voids are adjacent to opposite sidewalls of the heater element.

In ninth examples, for any of the eighth examples the second voids comprises a plurality of elongate voids aligned end-to-end along a longitudinal length of one of the first voids.

In tenth examples, for any of the seventh through ninth examples the second voids are spaced apart from the first voids by the dielectric material.

In eleventh examples, an apparatus comprises an electronic integrated circuit (EIC) and a photonic integrated circuit (PIC) coupled to the EIC through a plurality of interconnects. The PIC comprises an optical waveguide, a heater element between a plane of the optical waveguide and a plane of the interconnects, and a dielectric material between the heater element and the plane of the interconnects, wherein dielectric material comprises one or more voids between the heater element and the plane of the interconnects.

In twelfth examples, for any of the eleventh examples the PIC further comprises a metal-insulator-metal (MIM) capacitor between a plane of the interconnects and a second plane that is substantially parallel to the plane of the waveguide, and wherein the second plane passes between the MIM capacitor and the voids.

In thirteenth examples, for any of the eleventh through twelfth examples the heater element occupies an area of the PIC, and the voids comprise a single void that overlaps a majority of the area occupied by the heater element.

In fourteenth examples, for any of the thirteenth examples the single void overlaps an entirety of the area occupied by the heater element.

In fifteenth examples, for any of the eleventh through fourteenth examples the apparatus further comprises an optical coupler attached to the PIC.

In sixteenth examples, a method comprises receiving a photonic integrated circuit (PIC) structure comprising a dielectric material over a heater element and an optical waveguide, forming a void in the dielectric material and over the heater element, and forming one or more metallization levels over the void.

In seventeenth examples, for any of the sixteenth examples forming the void further comprises forming a sacrificial material feature over the heater elements, forming dielectric material over the sacrificial material feature, forming an opening through the dielectric material and exposing a portion of the sacrificial material feature, and removing the sacrificial material with an etchant provided through the opening.

In eighteenth examples, for any of the seventeenth examples forming the sacrificial material feature comprises depositing a thickness of dielectric material over the heater element, depositing a sacrificial material having a composition different than that of the dielectric material, and patterning the sacrificial material into the sacrificial material feature.

In nineteenth examples, for any of the seventeenth through eighteenth examples the sacrificial material feature has a width exceeding a corresponding width of the heater element and a length that spans a majority of a corresponding width of the heater element.

In twentieth examples, for any of the seventeenth through nineteenth examples the method further comprises occluding the opening to leave the void in place of the sacrificial material.

However, the above embodiments are not limited in this regard, and, in various implementations, the above embodiments may include the undertaking of only a subset of such features, undertaking a different order of such features, undertaking a different combination of such features, and/or undertaking additional features than those features explicitly listed. The scope of the disclosed techniques and architectures should therefore be determined with reference to the appended claims, along with the full scope of equivalents to which such claims are entitled.

What is claimed is:

1. An apparatus, comprising:
an optical waveguide;
a heater element over the optical waveguide; and
a dielectric material over and adjacent to heater element, wherein one or more voids within the dielectric material are over the heater element.

2. The apparatus of claim 1, wherein the heater element has a transverse width and a longitudinal length and wherein the voids span at least a majority of the longitudinal length.

3. The apparatus of claim 2, wherein a width of an individual one of the voids spans at least a majority of the transverse width.

4. The apparatus of claim 3, wherein the voids comprise one void spanning the majority of the longitudinal length and having a transverse width exceeding that of the heater element.

5. The apparatus of claim 1, wherein the one or more voids are vertically spaced apart from the heater element by less than 1000 nm.

6. The apparatus of claim 5, wherein the one or more voids are vertically spaced apart from the heater element by no more than a 300 nm thickness of the dielectric material.

7. The apparatus of claim 1, wherein the one or more voids are first voids and wherein the apparatus further comprises one or more second voids within the dielectric material and adjacent to a sidewall of the heater element.

8. The apparatus of claim 7, wherein the one or more second voids adjacent to the sidewall of the heater element comprise a pair of second voids, and wherein individual ones of the pair of second voids are adjacent to opposite sidewalls of the heater element.

9. The apparatus of claim 8, wherein the second voids comprises a plurality of elongate voids aligned end-to-end along a longitudinal length of one of the first voids.

10. The apparatus of claim 9, wherein the second voids are spaced apart from the first voids by the dielectric material.

11. An apparatus, comprising:
an electronic integrated circuit (EIC); and
a photonic integrated circuit (PIC) coupled to the EIC through a plurality of interconnects, wherein the PIC comprises:
an optical waveguide;
a heater element between a plane of the optical waveguide and a plane of the interconnects; and
a dielectric material between the heater element and the plane of the interconnects, wherein dielectric material comprises one or more voids between the heater element and the plane of the interconnects.

12. The apparatus of claim 11, wherein the PIC further comprises a metal-insulator-metal (MIM) capacitor between a plane of the interconnects and a second plane that is substantially parallel to the plane of the waveguide, and wherein the second plane passes between the MIM capacitor and the voids.

13. The apparatus of claim 11, wherein the heater element occupies an area of the PIC, and the voids comprise a single void that overlaps a majority of the area occupied by the heater element.

14. The apparatus of claim 13, wherein the single void overlaps an entirety of the area occupied by the heater element.

15. The apparatus of claim 11, further comprising an optical coupler attached to the PIC.

16. A method, comprising:
receiving a photonic integrated circuit (PIC) structure comprising a dielectric material over a heater element and an optical waveguide;
forming a void in the dielectric material and over the heater element; and
forming one or more metallization levels over the void.

17. The method of claim 16, wherein forming the void further comprises:
forming a sacrificial material feature over the heater element;
forming dielectric material over the sacrificial material feature;
forming an opening through the dielectric material and exposing a portion of the sacrificial material feature; and
removing the sacrificial material with an etchant provided through the opening.

18. The method of claim 17, wherein forming the sacrificial material feature comprises:
depositing a thickness of dielectric material over the heater element;
depositing a sacrificial material having a composition different than that of the dielectric material; and
patterning the sacrificial material into the sacrificial material feature.

19. The method of claim 18, wherein the sacrificial material feature has a width exceeding a corresponding width of the heater element and a length that spans a majority of a corresponding width of the heater element.

20. The method of claim 17, further comprising occluding the opening to leave the void in place of the sacrificial material.
